(19) United States
(12) Patent Application Publication
(10) Pub. No.: US 2009/0167539 A1
(43) Pub. Date: Jul. 2, 2009

(54) CRADLE DEVICE AND ELECTRONIC APPARATUS CONNECTABLE TO CRADLE DEVICE

(75) Inventors: Hironori MOTOE, Tokyo (JP); Shingo KOIDE, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/335,415

(22) Filed: Dec. 15, 2008

(30) Foreign Application Priority Data
Dec. 28, 2007 (JP) 2007-338765

(51) Int. Cl. G08B 17/12

(52) U.S. Cl. 340/600

(57) ABSTRACT

A cradle device includes: a magnetic sensor that outputs a detection signal that indicates an intensity of a magnetic field of a magnet provided in an electronic apparatus for detecting that the magnet is within a threshold distance; a power connection terminal that is connectable to a power source; a switching unit that switches to turn on and off the power supplied through the power connection terminal in accordance with the detection signal; and an apparatus connection terminal that is connectable to the electronic apparatus and supplies power supplied through the power connection terminal and the switching unit to the electronic apparatus.

### CROSS-REFERENCE TO RELATED APPLICATIONS

This application is based upon and claims the benefit of priority from Japanese Patent Application No. 2007-338765, filed on Dec. 28, 2007, the entire content of which are incorporated herein by reference.

### BACKGROUND

1. Field

One embodiment of the present invention relates to a cradle device for extending a function of an electronic apparatus and the electronic apparatus connectable to the cradle device.

2. Description of the Related Art

A portable electronic apparatus such as a portable personal computer and a PDA (Personal Digital Assistant) is configured so as to use a device (hereinafter, referred to as a cradle device) having an extension function for extending a function useable by a user, while maintaining a portability of the electronic apparatus.

The electronic apparatus and the cradle device have respective connection terminals to be electrically connected to each other. The respective connection terminals provided in the electronic apparatus and the cradle device are disposed so as to be fitted to each other when the electronic apparatus is placed on a placement portion provided in the cradle device, for example.

When the electronic apparatus is connected to the cradle device, a user charges a battery incorporated with the electronic apparatus using power supplied from the cradle device or can operate the electronic apparatus using an input device such as a mouse connected to the cradle device through the USB terminal.

On the other hand, when the electronic apparatus is not connected to the cradle device, it is desirable that power consumption is reduced or the power supply from a commercial power source or the like to the cradle device is blocked in order to prevent a short-circuited accident caused due to contact of a metal piece with the connection terminal of the cradle device.

Conventionally, there is disclosed in JP-A-5-066858 a technique for controlling the power supply depending on a connection state of the electronic apparatus and the cradle device.

The cradle device disclosed in the document, JP-A-5-066858, includes a unit for supplying power to the electronic apparatus, a unit for recognizing a state where the electronic apparatus is connected, and a unit for blocking the power supply to the electronic apparatus when it is recognized that the electronic apparatus has not been connected. Accordingly, when the electronic apparatus is not connected, the power supply to the electronic apparatus is configured to be blocked.

Recently, a smaller portable electronic apparatus has been developed and a small electronic apparatus with an A5 size or a smaller size can be seen. Accordingly, it is necessary for the small electronic apparatus to have a smaller connection terminal to be connected to the cradle device.

However, the known technique has a problem in that the connection terminal becomes necessarily large since a signal (recognition signal) for recognizing the connection with or the disconnection from the electronic apparatus has to be transmitted through the connection terminal in order for the cradle device to recognize the connection with or the disconnection from the electronic apparatus. For that reason, the known technique is not appropriate for the small electronic apparatus with the A5 size or the smaller size.

### SUMMARY

One of objects of the present invention is to provide a cradle device capable of easily determining whether the cradle device and an electronic apparatus are connected to each other without using a connection terminal and the electronic apparatus to be connected to the cradle device.

According to a first aspect of the present invention, there is provided a cradle device for extending a function of an electronic apparatus, the cradle device including: a magnetic sensor that outputs a detection signal that indicates an intensity of a magnetic field of a magnet provided in the electronic apparatus for detecting that the magnet is within a threshold distance when the intensity of the magnetic field is equal to or more than a threshold intensity; a power connection terminal that is connectable to a power source to receive power supplied from the power source; a switching unit that switches to turn on and off the power supplied through the power connection terminal in accordance with the detection signal output from the magnetic sensor; and an apparatus connection terminal that is connectable to the electronic apparatus and supplies power supplied through the power connection terminal and the switching unit to the electronic apparatus, wherein the switching unit switches to turn on the power supplied through the power connection terminal when the detection signal indicating that the intensity of the magnetic field is equal to or more than the threshold intensity is received, and wherein the switching unit switches to turn off the power supplied through the power connection terminal when the detection signal indicating that the intensity of the magnetic field is less than the threshold intensity is received.

According to a second aspect of the present invention, there is provided a cradle device for extending a function of an electronic apparatus, the cradle device including: a magnetic sensor that outputs a detection signal that indicates an intensity of a magnetic field of a magnet provided in the electronic apparatus for detecting that the magnet is within a threshold distance when the intensity of the magnetic field is equal to or more than a threshold intensity; a power connection terminal that is connectable to a power source to receive power supplied from the power source; and a first switching unit that switches to turn on and off the power supplied through the power connection terminal in accordance with the detection signal output from the magnetic sensor; an apparatus connection terminal that is connectable to the electronic apparatus and supplies power supplied through the power connection terminal and the switching unit to the electronic apparatus; an external device connection terminal that is electrically connected to the switching unit in parallel with the apparatus connection terminal for connecting an external apparatus; a second switching unit that is provided between the apparatus connection terminal and a connection point of the apparatus connection terminal and the external device connection terminal; and a switch control unit that controls the first switching unit and the second switching unit to turn on and off based on one of a first setting and a second setting when the detection signal indicating that the intensity of the magnetic field is less than the threshold intensity is received, wherein the first setting is to turn off the power from the power source to the apparatus connection terminal and the external device connection terminal by turning off the first switching unit and the second switching unit, and wherein the second setting is to turn off the power supply to the apparatus connection terminal and to turn on the power supply to the external device connection terminal by turning on the first switching unit and turning off the second switching unit.

According to a third aspect of the present invention, there is provided an electronic apparatus connectable to a cradle device, wherein the cradle device includes: a magnetic sensor that outputs a detection signal that indicates an intensity of a magnetic field of a magnet provided in the electronic apparatus for detecting that the magnet is within a threshold distance when the intensity of the magnetic field is equal to or more than a threshold intensity; a power connection terminal that is connectable to a power source to receive power supplied from the power source; a switching unit that switches to turn on and off the power supplied through the power connection terminal in accordance with the detection signal output from the magnetic sensor; and an apparatus connection terminal that is connectable to the electronic apparatus and supplies power supplied through the power connection terminal and the switching unit to the electronic apparatus, wherein the switching unit switches to turn on the power supplied through the power connection terminal when the detection signal indicating that the intensity of the magnetic field is equal to or more than the threshold intensity is received, wherein the switching unit switches to turn off the power supplied through the power connection terminal when the detection signal indicating that the intensity of the magnetic field is less than the threshold intensity is received, wherein the electronic apparatus comprises the magnet that is disposed at a position where the magnetic sensor of the cradle device detects the magnetic field having the intensity equal to or more than the threshold intensity when the electronic apparatus is connected to the cradle device.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a diagram illustrating an overall configuration of a cradle device and an electronic apparatus connected to the cradle device according to a first embodiment of the invention.

FIG. 2 is a front perspective view illustrating the cradle device.

FIG. 3 is a front view illustrating the electronic apparatus.

FIG. 4 is a front view illustrating an example where the electronic apparatus is connected to the cradle device 20.

FIG. 5 is a rear perspective view illustrating the cradle device.

FIG. 6 is a schematic block diagram illustrating an example of the inside configuration of the cradle device according to the first embodiment.

FIG. 7 is a diagram for explaining a relationship between a threshold distance within which a magnetic sensor can sense a magnet and a threshold protrusion length of an apparatus connection terminal.

FIG. 8 is a schematic block diagram illustrating an example of the inner configuration of a cradle device according to a second embodiment.

### DETAILED DESCRIPTION

Embodiments of an information processing apparatus of the invention will be discussed with reference to the accompanying drawings.

A cradle device and an electronic apparatus according to embodiments of the invention will be described with reference to the accompanying drawings.

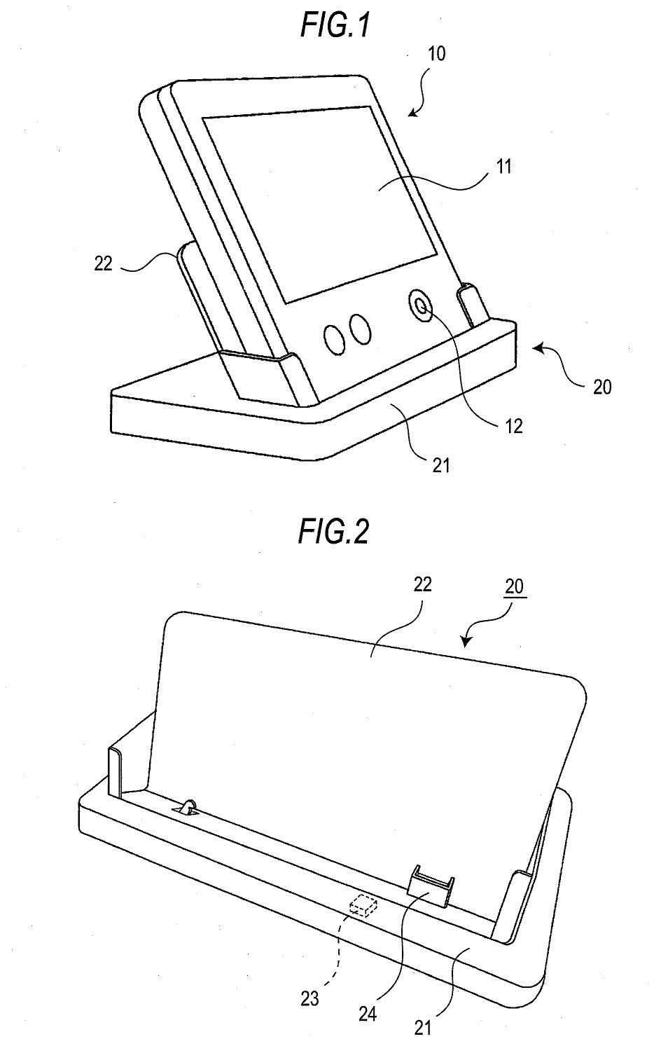

FIG. 1 is a diagram illustrating an overall configuration of a cradle device and an electronic apparatus connected to the cradle device according to a first embodiment of the invention. FIG. 1 shows that the electronic apparatus is connected to the cradle device.

An electronic apparatus 10 includes an LCD 11, which is a display unit of a display input unit formed in the center portion of a case upper surface, and a power button 12 which is formed in the case upper surface.

The display input unit includes the LCD 11 as the display unit and a pen tablet unit or a touch panel as an input unit.

The cradle device 20 is a device for extending functions which can be used by a user while maintaining portability of the electronic apparatus 10. The cradle device 20 includes a base support portion 21 for containing various circuits and a body support portion 22 for supporting the electronic apparatus 10 connected to the cradle device 20.

FIG. 2 is a front perspective view illustrating the cradle device 20. As shown in FIG. 2, the cradle device 20 further includes a magnetic sensor 23 disposed inside the base support portion 21 and an apparatus connection terminal 24 to be electrically connected to the electronic apparatus 10.

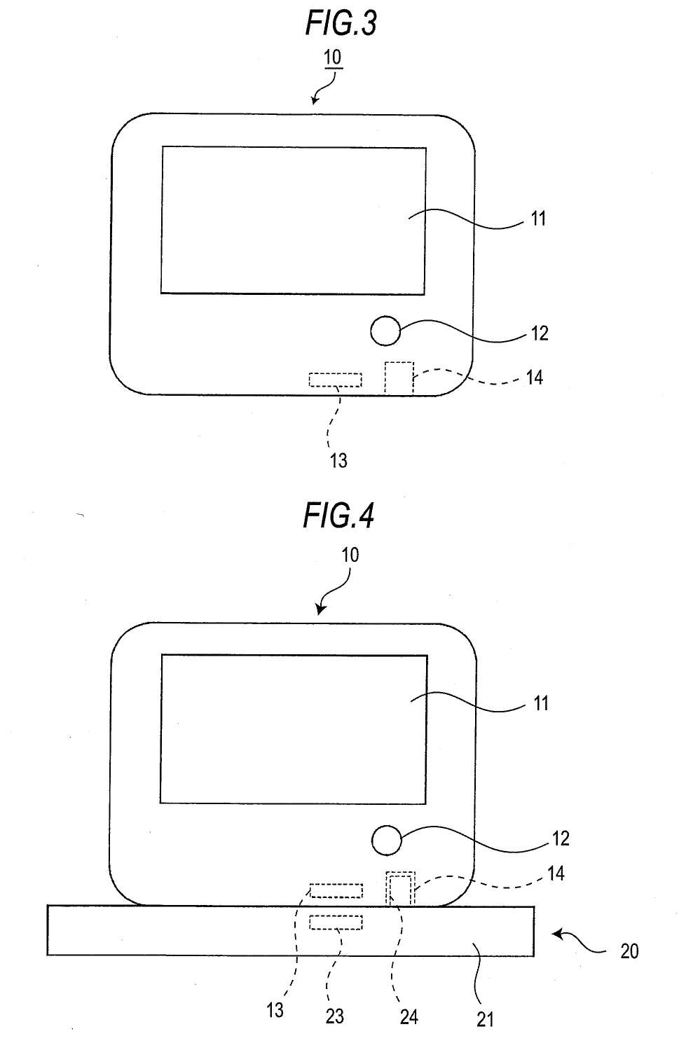

FIG. 3 is a front view illustrating the electronic apparatus 10. The electronic apparatus 10 further includes a magnet 13, which is disposed near the magnetic sensor 23 of the cradle device 20 when the electronic apparatus 10 is connected to the cradle device 20, and an extension connection terminal 14, which can be electrically connected to the apparatus connection terminal 24 of the cradle device 20.

FIG. 4 is a front view illustrating an example where the electronic apparatus 10 has been connected to the cradle device 20.

As shown in FIG. 4, the magnet 13 and the magnetic sensor 23 are disposed in the electronic apparatus 10 and the cradle device 20, respectively, so as to be close to each other when the extension connection terminal 14 of the electronic apparatus 10 is connected to the apparatus connection terminal 24 of the cradle device 20.

More specifically, the magnetic sensor 23 is configured so as to sense that the magnet 13 provided in the electronic apparatus 10 is within a threshold distance by detecting a magnetic field having an intensity equal to or more than a threshold intensity. In addition, the magnet 13 is disposed at a position from which the magnetic sensor 23 can detect the magnetic field having the intensity equal to or more than the threshold intensity when the electronic apparatus 10 is connected to the cradle device 20.

One of the apparatus connection terminal 24 and the extension connection terminal 14 has a protruding shape with a threshold length from a case of the one the cradle device 20 and the electronic apparatus 10, and the other of the apparatus connection terminal 24 and the extension connection terminal 14 has a concave shape for fitting to the one of the apparatus connection terminal 24 and the extension connection terminal 14. In this embodiment, the apparatus connection terminal 24 provided in the cradle device 20 has the protruding shape with the threshold length from the case, and the extension connection terminal 14 provided in the electronic apparatus 10 has the concave shape for fitting to the apparatus connection terminal 24.

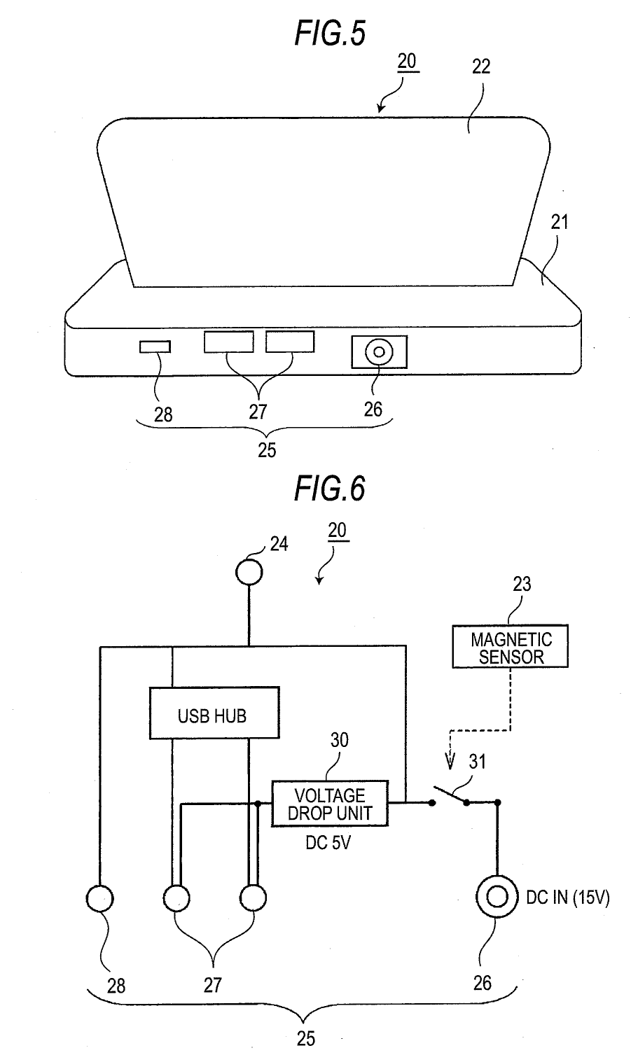

FIG. 5 is a rear perspective view illustrating the cradle device 20. As shown in FIG. 5, a power connection terminal 25, which is connected to a commercial power source to receive power from a power source, and an external device connection terminal group 26 are provided on the rear surface of the base support 21 of the cradle device 20. The external device connection terminal group 26 includes a USB (Universal Serial Bus) type-A receptacle 27 and a USB type-B receptacle 28.

When the electronic apparatus 10 is connected to the cradle device 20 (see FIG. 4), a user charges a battery incorporated with the electronic apparatus 10 using the power supplied from the cradle device 20 or can operate the electronic apparatus 10 using an input device such as a mouse connected to the cradle device 20 through the USB type-A receptacle 27.

The USB type-A receptacle 27 includes a power supply line as well as a signal line. Accordingly, the power can be supplied to the external apparatus connected to the cradle device 20 through the power supply line of the USB type-A receptacle 27. The power supplied through the USB type-A receptacle 27 has a voltage value of 5 V, for example.

FIG. 6 is a schematic block diagram illustrating an example of the inside configuration of the cradle device 20.

As shown in FIG. 6, the cradle device 20 further includes a voltage drop unit 30 and a switching unit 31 of which one end is connected to the power connection terminal 25. The other end of the switching unit 31 is connected to the apparatus connection terminal 24 and the USB type-A receptacle 27.

FIG. 6 shows an example where an alternating-current voltage supplied from the commercial power source is changed into a direct current voltage of 15 V to be supplied to the power connection terminal 25 by an AC adapter or the like and the direct current voltage of 15 V is supplied to the apparatus connection terminal 24.

When the voltage to be supplied through the USB type-A receptacle 27 is 5 V, the direct current voltage of 15 V supplied through the power connection terminal 25 drops to 5 V by the voltage drop unit 30 to be supplied to the USB type-A receptacle 27, as shown in FIG. 6.

An output signal of the magnetic sensor 23 is input to the switching unit 31. The switching unit 31 shorts connection when it receives an output signal indicating the detection of the magnetic field having the intensity equal to or more than the threshold intensity from the magnetic sensor 23. Alternatively, the switching unit 31 opens the connection when it receives an output signal indicating the detection of the magnetic field having the intensity less than the threshold intensity from the magnetic sensor 23.

Next, an example of an operation of the cradle device 20 and the electronic apparatus 10 to be connected to the cradle device 20 according to this embodiment will be described.

The magnetic sensor 23 detects that the magnet 13 provided in the electronic apparatus 10 is within the threshold distance by detecting the magnetic field having the intensity equal to or more than the threshold intensity and outputs the signal indicating the detection of the magnetic field to the switching unit 31 when the electronic apparatus 10 is connected to the cradle device 20. The switching unit 31 receives the signal indicating the detection of the magnetic field having the intensity equal to or more than the threshold intensity from the magnetic sensor 23 and shorts the connection.

As a result, when the power connection terminal 25 and the apparatus connection terminal 24 are electrically connected to each other, the direct current voltage of 15 V is supplied to the apparatus connection terminal 24. Moreover, when the power connection terminal 25 and the USB type-A receptacle 27 are electrically connected to each other, the direct current voltage of 5 V is supplied to the USB type-A receptacle 27.

On the other hand, when the electronic apparatus 10 is disconnected from the cradle device 20, the magnetic sensor 23 outputs a signal indicating the detection of the magnetic field having the intensity less than the threshold intensity. The switching unit 31 receives the signal indicating the detection of the magnetic field having the intensity less than the threshold intensity from the magnetic sensor 23 to open the connection.

As a result, when the connection between the power connection terminal 25 and the apparatus connection terminal 24 are opened, the supply of the direct current voltage to the apparatus connection terminal 24 is blocked. Moreover, when the connection between the power connection terminal 25 and the USB type-A receptacle 27 is opened, the supply of the direct current voltage to the USB type-A receptacle 27 is also blocked.

In the cradle device 20 and the electronic apparatus 10 to be connected to the cradle device 20 according to this embodiment, it is possible to easily determine whether the cradle device 20 and the electronic apparatus 10 are connected to each other, by using the magnetic sensor 23 and the magnetic 13 without using the connection terminals (the apparatus connection terminal 24 and the extension connection terminal 14). Accordingly, it is not necessary to install a signal line for recognizing connection with the connection terminals (the apparatus connection terminal 24 and the extension connection terminal 14). Moreover, it is possible to miniaturize the connection terminals (the apparatus connection terminal 24 and the extension connection terminal 14).

As a result, in the cradle device 20 and the electronic apparatus 10 to be connected to the cradle device 20 according to this embodiment, it is possible to easily determine whether the cradle device 20 and the electronic apparatus 10 are connected to each other while miniaturizing the electronic apparatus 10 and the cradle device 20.

In the cradle device 20 and the electronic apparatus 10 to be connected to the cradle device 20 according to this embodiment, the magnetic sensor 23 and the magnet 13 are installed in the cradle device 20 and the electronic apparatus 10, respectively, and the magnetic sensor 23 detects the magnetic field generated by the magnet 13. With such a configuration, whether the cradle device 20 and the electronic apparatus 10 are connected to each other is determined. Accordingly, it is possible to easily sense one another by adjusting a relative position of the magnetic sensor 23 and the magnet 13.

For example, if a magnet 13 of another electronic apparatus 10 mounted in the another electronic apparatus 10 having the same extension connection terminal 14 is mounted at a position different from the position where the extension connection terminal 14 is mounted in the electronic apparatus 10, the cradle device 20 does not supply power to the apparatus connection terminal 24 even though the another electronic apparatus 10 is connected. Accordingly, it is possible to beforehand prevent an accident occurring when the different electronic apparatus 10 is erroneously connected.

The reason for blocking the power supply to the apparatus connection terminal 24 of the cradle device 20 when the electronic apparatus 10 is connected to the cradle device 20 is to reduce standby electricity of the cradle device 20 and prevent a short-circuited accident caused due to the contact of a metal piece with the exposed apparatus connection terminal 24.

In order to prevent the short-circuited accident caused due to the contact of the metal piece with the exposed apparatus connection terminal 24, it is desirable that the power supply to the apparatus connection terminal 24 is surely blocked before the apparatus connection terminal 24 is exposed.

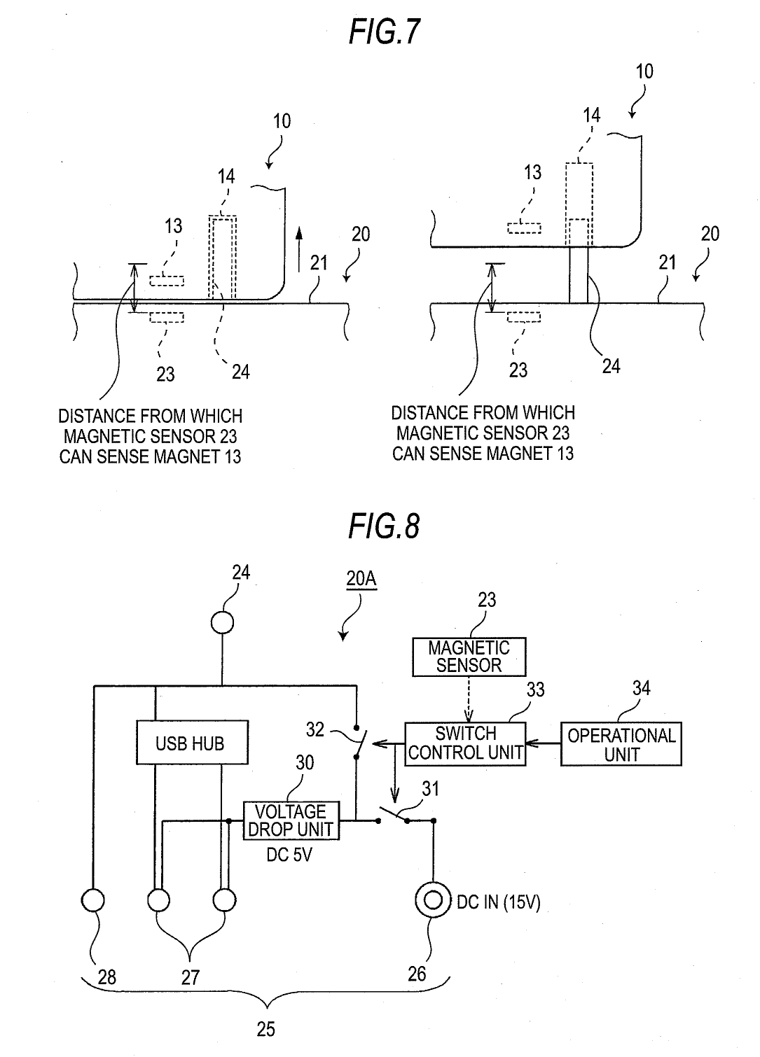

FIG. 7 is a diagram for explaining a relationship between a threshold distance within which the magnetic sensor 23 can sense the magnet 13 and a protruding threshold length of the apparatus connection terminal 24.

In order to surely block the power supply to the apparatus connection terminal 24 before the apparatus connection terminal 24 is exposed, it is necessary to adjust the protruding threshold length of the apparatus connection terminal 24. Specifically, the protruding threshold length of the apparatus connection terminal 24 is set to a length within which the magnetic sensor 23 can sense that the magnet 13 is not present before the fitting of the apparatus connection terminal 24 and the extension connection terminal 14 is completely released.

Next, a cradle device 20A and an electronic apparatus 10 to be connected to the cradle device 20A according to a second embodiment of the invention will be described.

The cradle device 20A according to the second embodiment is different from the cradle device 20 according to the first embodiment in that power supply to an apparatus connection terminal 24 is blocked, but the power supply to a USB type-A receptacle 27 is allowed, when the electronic apparatus 10 is not connected to the cradle device 20A. The same Reference Numerals are given to the same constituent elements and the description is omitted since the rest configuration and the operation of the cradle device 20A is not substantially different from those of the cradle device 20 and the electronic apparatus 10 connected to the cradle device 20 shown in FIG. 1.

FIG. 8 is a schematic block diagram illustrating an example of the inner configuration of a cradle device 20A according to a second embodiment.

As shown in FIG. 8, the cradle device 20A further includes another switching unit 32, a switch control unit 33, and an operational unit 34.

The another switching unit 32 is connected between the apparatus connection terminal 24 and a connection point of the USB type-A receptacle 27 and the apparatus connection terminal 24.

The switch control unit 33 controls shorting and opening of the switching unit 31 and the another switching unit 32 on the basis of one of first setting and second setting when the switch control unit 33 receives an output signal indicating detection of a magnetic field having an intensity less than a threshold intensity from a magnetic sensor. The switch control unit 33 controls the switching unit 31 and the another switching unit 32 so as to be shorted when the switch control unit 33 receives an output signal indicating detection of a magnetic field having an intensity equal to or more than a threshold intensity from the magnetic sensor.

The first setting is to block the power supply to the apparatus connection terminal 24 and the USB type-A receptacle 27 by opening the connection between the switching unit 31 and the power connection terminal 25 and the connection between the another switching unit 32 and the power connection terminal 25. In addition, the second setting is to allow the power supply to the USB type-A receptacle 27, but block the power supply to the apparatus connection terminal 24 by shorting the switching unit 31 and opening the another switching unit 32.

The operational unit 34 supplies the switch control unit 33 with information indicating which setting is used to perform the controlling between the first setting and the second setting. For example, the operational unit 34 may be provided as a slide switch on the side surface of a base support portion 21. If the slide switch is used, the slide switch is configured so as to be positioned in a first state and a second state. When the slide switch is positioned in the first state, the information indicating that the first setting is necessary is supplied to the switch control unit 33. Alternatively, when the slide switch is positioned in the second state, the information indicating that the second setting is necessary is supplied to the switch control unit 33.

The cradle device 20A and the electronic apparatus 10 to be connected to the cradle device 20A according to this embodiment have the same advantage as that of the cradle device 20 and the electronic apparatus 10 to be connected to the cradle device 20 according to the first embodiment.

In the cradle device 20A and the electronic apparatus 10 to be connected to the cradle device 20A according to this embodiment, it is possible to prevent a short-circuited accident caused due to contact of a metal piece with the apparatus connection terminal 24 by blocking the power supply to the apparatus connection terminal 24 when the electronic apparatus 10 is not connected, for example. Moreover, it is possible to continue the power supply to an external apparatus which is connected to the USB type-A receptacle 27 to be electrically charged or the like.

As described above, in a cradle device and an electronic apparatus to be connected to the cradle device according to the present invention, it is possible to easily determine whether the cradle device and the electronic apparatus are connected to each other.

The present invention is not limited to the above-described embodiments, but may be modified into various forms without departing from the gist of the invention by modifying the constituent elements. For example, the switch control unit may be realized as a processor. Moreover, the plural constituent elements in the above-described embodiments may be appropriately combined to form various aspects of the invention. For example, several constituent elements may be omitted from the entire constituent elements in the above-described embodiments. Furthermore, the constituent elements in the different embodiments may be appropriately combined.

What is claimed is:

1. A cradle device for extending a function of an electronic apparatus, the cradle device comprising:
a magnetic sensor configured to output a signal indicative of an intensity of a magnetic field of a magnet in the electronic apparatus when the magnet is within a threshold distance by detecting that the intensity of the magnetic field is equal to or more than a threshold intensity;
a power connection terminal configured to connect to a power source;
a switch configured to turn between on and off the power supplied through the power connection terminal in accordance with the signal output from the magnetic sensor; and
an apparatus connection terminal configured to connect to the electronic apparatus and to supply the power from the switch to the electronic apparatus,
wherein the switch is configured to turn on the power supplied through the power connection terminal when the received signal indicates that the intensity of the magnetic field is equal to or more than the threshold intensity, and
wherein the switch is configured to turn off the power supplied through the power connection terminal when the received signal indicates that the intensity of the magnetic field is less than the threshold intensity.

2. The cradle device of claim 1 further comprising an external device connection terminal electrically connected to the switch in parallel with the apparatus connection terminal in order to connect to an external apparatus,
wherein the power is supplied to the external device connection terminal when the switch turns on the power, and
wherein the power supplied to the external device connection terminal is turned off when the switch turns off the power.

3. The cradle device of claim 1, wherein the electronic apparatus comprises an extension connection terminal configured to electrically connect to the apparatus connection terminal,
wherein either the apparatus connection terminal is configured to protrude by a threshold length from a case of the cradle device and the extension connection terminal comprises a concave shape for fitting to the apparatus connection terminal; or
the extension connection terminal is configured to protrude by a determined length from a case of the electronic apparatus and the apparatus connection terminal comprises a concave shape for fitting to the extension connection terminal.

4. The cradle device of claim 3, wherein the threshold length is a length within which the magnetic sensor is configured to output the signal indicative of the intensity of the magnetic field less than the threshold intensity before the apparatus connection terminal and the extension connection terminal are completely disconnected from each other.

5. The cradle device of claim 1, wherein the external device connection terminal is configured to comply with a universal serial bus standard.

6. A cradle device for extending a function of an electronic apparatus, the cradle device comprising:
a magnetic sensor configured to output a signal indicative of an intensity of a magnetic field of a magnet in the electronic apparatus when the magnet is within a threshold distance by detecting that the intensity of the magnetic field is equal to or more than a threshold intensity;
a power connection terminal configured to connect to a power source; and
a first switch configured to turn on and off the power supplied through the power connection terminal in accordance with the signal output from the magnetic sensor;
an apparatus connection terminal configured to connect to the electronic apparatus and to supply the power from the first switch to the electronic apparatus;
an external device connection terminal electrically connected to the first switch in parallel with the apparatus connection terminal configured to connect to an external apparatus;
a second switch between the apparatus connection terminal and a connection point of the apparatus connection terminal and the external device connection terminal; and
a switch controller configured to control the first switch and the second switch to turn on and off based on either a first setting or a second setting when the received signal indicates that the intensity of the magnetic field is less than the threshold intensity,
wherein the first setting is to turn off the power from the power source to the apparatus connection terminal and the external device connection terminal by turning off the first switch and the second switch, and
wherein the second setting is to turn off the power supply to the apparatus connection terminal and to turn on the power supply to the external device connection terminal by turning on the first switch and turning off the second switch, respectively.

7. The cradle device of claim 6 further comprising a receiver configured to receive an input for changing between the first setting and the second setting.

8. An electronic apparatus configured to connect to a cradle device, wherein the cradle device comprises:
a magnetic sensor configured to output a signal indicative of an intensity of a magnetic field of a magnet in the electronic apparatus when the magnet is within a threshold distance by detecting that the intensity of the magnetic field is equal to or more than a threshold intensity;
a power connection terminal configured to connect to a power source;
a switch configured to turn on and off the power supplied through the power connection terminal in accordance with the signal output from the magnetic sensor; and
an apparatus connection terminal configured to connect to the electronic apparatus and to supply power from the switch to the electronic apparatus,
wherein the switch is configured to turn on the power supplied through the power connection terminal when the received signal indicates that the intensity of the magnetic field is equal to or more than the threshold intensity,
wherein the switch is configured to turn off the power supplied through the power connection terminal when the received signal indicates that the intensity of the magnetic field is less than the threshold intensity,
wherein the electronic apparatus comprises the magnet disposed at a position where the magnetic sensor of the cradle device detects the magnetic field of the intensity equal to or more than the threshold intensity when the electronic apparatus is connected to the cradle device.

9. The electronic apparatus of claim 8, wherein the cradle device further comprises an external device connection terminal electrically connected to the switch in parallel with the apparatus connection terminal in order to connect to an external apparatus,
wherein the power is supplied to the external device connection terminal when the switch turns on the power, and
wherein the power supplied to the external device connection terminal is turned off when the switch turns off the power.

10. The electronic apparatus of claim 8 further comprising an extension connection terminal configured to electrically connect to the apparatus connection terminal of the cradle device,
wherein either the apparatus connection terminal is configured to protrude by a threshold length from a case of the cradle device and the extension connection terminal comprises a concave shape for fitting to the apparatus connection terminal; or
the extension connection terminal is configured to protrude by a determined length from a case of the electronic apparatus and the apparatus connection terminal comprises a concave shape for fitting to the extension connection terminal.

11. The electronic apparatus of claim 10, wherein the threshold length is a length within which the magnetic sensor is configured to output the signal indicative of the intensity of the magnetic field less than the threshold intensity before the apparatus connection terminal and the extension connection terminal are completely disconnected from each other.

12. The electronic apparatus of claim 8, wherein the external device connection terminal is configured to comply with a universal serial bus standard.

13. The electronic apparatus of claim 8, wherein the cradle device further comprises an external device connection terminal electrically connected to the switch in parallel with the apparatus connection terminal in order to connect to an external apparatus,
wherein the switch comprises:
a first switch configured to turn on and off the power supplied through the power connection terminal in accordance with the signal output from the magnetic sensor; and
a second switch between the apparatus connection terminal and a connection point of the apparatus connection terminal and the external device connection terminal,
wherein the cradle device further comprises a switch controller configured to control the first switch and the second switch to turn on and off based on one of a first setting and a second setting when the received signal is indicative of the intensity of the magnetic field less than the threshold intensity,
wherein the first setting is to turn off the power from the power source to the apparatus connection terminal and the external device connection terminal by turning off the first switch and the second switch, and
wherein the second setting is to turn off the power supply to the apparatus connection terminal and to turn on the power supply to the external device connection terminal by turning on the first switch and turning off the second switch.

14. The electronic apparatus of claim 13, wherein the cradle device further comprises a receiver configured to receive an input for switching between the first setting and the second setting.
